(19) United States
(12) Patent Application Publication
(10) Pub. No.: US 2025/0227723 A1
(43) Pub. Date: Jul. 10, 2025

(54) TRANSMITTING POSITION REFERENCE SIGNAL CONFIGURATIONS FOR WIRELESS COMMUNICATIONS

(71) Applicant: ZTE Corporation, Shenzhen (CN)

(72) Inventors: Yu PAN, Shenzhen (CN); Chuangxin JIANG, Shenzhen (CN); Jiajun CHEN, Shenzhen (CN); Mengzhen LI, Shenzhen (CN); Jing LIU, Shenzhen (CN)

(73) Assignee: ZTE Corporation, Shenzhen, GD (CN)

(21) Appl. No.: 19/088,559

(22) Filed: Mar. 24, 2025

Related U.S. Application Data
(63) Continuation of application No. PCT/CN2022/122953, filed on Sep. 29, 2022.

(51) Int. Cl. H04W 72/25; H04L 5/00; H04W 72/1263

(52) U.S. Cl. CPC H04W 72/25; H04L 5/0051; H04W 72/1263

(57) ABSTRACT

This document generally relates to wireless communication that includes a location management function (LMF) and at least one radio access network (RAN) node that perform an interaction associated with at least one sidelink positioning reference signal (SL-PRS) configuration. The LMF or the at least one RAN node transmits a plurality of non-overlapping SL-PRS configurations to a plurality of user devices based on the interaction.

### CROSS-REFERENCE TO RELATED APPLICATIONS

The present application is a continuation of International Patent Application No. PCT/CN2022/122953, filed Sep. 29, 2022. The contents of International Patent Application No. PCT/CN2022/122953 are herein incorporated by reference in their entirety.

### TECHNICAL FIELD

This document is directed generally to sidelink positioning for wireless communication.

### BACKGROUND

In a sidelink positioning mode 1 scenario, different sidelink user devices may have different serving gNBs. There may exist one or more mode 1 user devices under one gNB's scope or coverage, and the one or more mode 1 user devices may interact with this gNB via control signaling. Mode 1 user devices under the same or different gNBs should receive different or non-overlapped sideling position reference signal (SL-PRS) configurations in order to avoid conflict when sending SL-PRSs to other sidelink user devices. In event that different serving gNBs provide SL-PRS configurations to their corresponding user devices, since different gNBs will not coordinate their SL-PRS configurations or perform conflict resolution with each other, then different user devices may receive overlapped SL-PRS configurations (e.g. in the time domain or frequency domain), which in turn may cause interference when the user devices send SL-PRSs. As such, ways to avoid overlapping SL-PRS configurations may be desirable.

### SUMMARY

This document relates to methods, systems, apparatuses and devices for wireless communication. In some implementations, a method for wireless communication includes: performing, with a location management function (LMF) and at least one radio access network (RAN) node, an interaction associated with at least one sidelink positioning reference signal (SL-PRS) configuration; and transmitting, with the LMF or the at least one RAN node, a plurality of non-overlapping SL-PRS configurations to a plurality of user devices based on the interaction.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a wireless access node of the wireless communication system of FIG. 1.

FIG. 3 shows a block diagram illustrating a sidelink positioning structure for an in-coverage scenario of the wireless system of FIGS. 1 and 2.

FIG. 4 shows a flow chart of an example method for wireless communication.

### DETAILED DESCRIPTION

The present description describes various embodiments of systems, apparatuses, devices, and methods for wireless communications that relates to sidelink positioning.

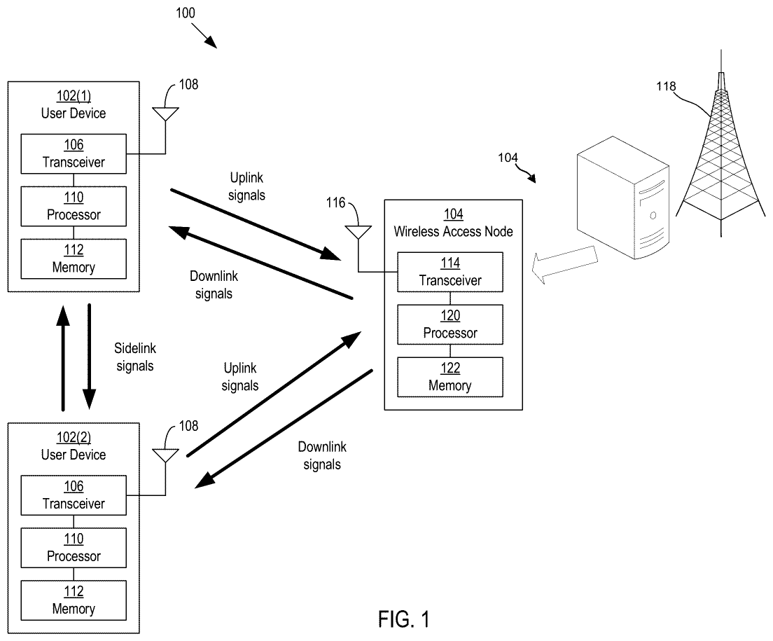

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

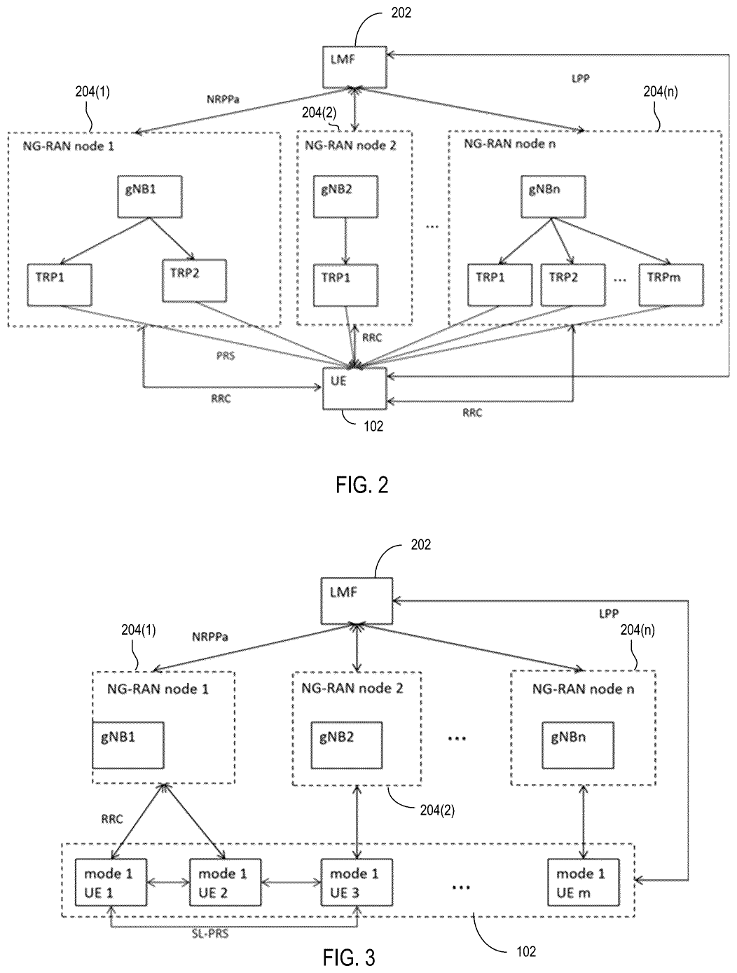

FIG. 2 shows a block diagram of an example configuration of a wireless access node 104. In the example configuration, the wireless access node 104 may include a location management function (LMF) 202 and one or more radio access network (RAN) nodes 204. Some embodiments may include only one RAN node 204. Other embodiments, such as shown in FIG. 2, may include a plurality, or an n-number, of RAN nodes 204(1) to 204(n), where n is two or more. The LMF 202 and each RAN node 204 may each be configured in hardware or a combination of hardware and software, such as by having a processor 120, a memory 122, transceiver circuitry 114, an antenna 116, and/or an antenna tower 118, such as shown in FIG. 1 for the wireless access node 104.

Additionally, as shown in FIG. 2, the LMF 202 and each of the RAN nodes 204 may be configured to communicate (transmit and receive) with each other, such as signals or messages, and may be configured to communicate (transmit and receive) with one or more user device 102, either directly or indirectly via another component of the wireless access node 104. For example, the LMF 202 may directly communicate with a user device 102. In particular embodiments, the LMF 202 may directly communicate with a user device 102 according to a Long-Term Evolution (LTE) positioning protocol (LPP) (i.e., via LPP signaling). Also, a RAN node 204 may directly communicate with a user device 102. In particular embodiments, a RAN node 204 may directly communicate with a user device 102 at least via radio resource control (RRC) signaling. In addition, the LMF 202 may directly communicate with each RAN node 204. In particular embodiments, the LMF 202 may directly communicate with each RAN node 204 according to New Radio Positioning Protocol A (NRPPa) (i.e., via NRPPa signaling). Also, for at least some embodiments, such as shown in FIG. 2, each RAN node 204 may include one or more sub-components. For example, a RAN node 204 may include a gNB and/or at least one a transmission/reception point (TRP). Further functionality of the LMF 202 and the RAN nodes 204 is described in further detail below.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

In further detail, in sidelink positioning, user devices 102 may be in different scenarios, such as, in coverage, partial coverage, or out of coverage. For in coverage and partial coverage scenarios, the user device 102 has a network connection with the wireless access node 104, and can communicate (receive and/or transmit) signals/signaling with the wireless access node 104 (e.g., the network), including the RAN node(s) 204 and the LMF 202. At the same time, a user device 102 may interact (communicate (transmit and/or receive) signals/signaling with other user devices 102. For the out of coverage scenario, a user device 102 has no connection with the wireless access node 104 (e.g., the network), and the user device 102 can only communicate (transmit and/or receive) signals/signaling with other user devices 102.

Also, for at least some embodiments, in sidelink positioning, there is mode 1 and mode 2. Mode 1 is for in-coverage and partial coverage user devices 102 to explicitly receive sending and/or receiving configurations (e.g., transmit (Tx) resource pool, receive (Rx) resource pool, data/signal sending positioning in time and frequency domain) from the network 104 without sensing before transmission. Mode 2 is for user devices 102 that need to perform sensing of sidelink control information (SCI) before transmission data, in order to ensure the resources will not be occupied by any other user devices 102. In the in-coverage scenario, a user device 102 may operate in mode 1 or mode 2, which, in some embodiments, may depend on the gNB's explicit signaling. Also, a user device 102 may be configured or operate as a target user device or an anchor user device. In some embodiments, the mode 1 and mode 2 can also be called scheme 1 and scheme 2, respectively.

Also, for at least some implementations, original positioning performed by a user device 102 may use a mobile terminal-location request (MT-LR) structure or a mobile originated location request (MO-LR) structure. MT-LR is a LMF-triggered location request to a user device 102 and RAN nodes 204 at the very first beginning of the original positioning, and this location request may originate at an external location service (LCS) client. Additionally, with MO-LR, the user device 102 triggers a location request to the LMF 202 at the very first beginning of the original positioning, in order to know the location of itself. For at least some implementations, these two structures are applied to sidelink positioning.

Additionally, a positioning session may be set up by a high layer, and each positioning session may correspond to one service type, e.g. one MT-LR or one MO-LR. In original positioning, the communication nodes involved in one positioning session may include one LMF 202, a plurality of RAN nodes 204, and one user device 102. In sidelink positioning, the communication nodes involved in one sidelink positioning session may include one LMF 202, a plurality of NG-RAN nodes, and a plurality of user devices 102. The plurality of user devices 102 may include one target user device 102 and one or more anchor user devices 102 to perform sidelink positioning, or multiple user devices 102 may include a mode 1 user device 102, a mode 2 user device 102, and a user device 102 that performs Uu-based positioning. Also, the plurality of RAN nodes 204 may include a plurality of serving RAN nodes 204 for the plurality of user device 102 or the RAN nodes 204 supporting Uu-based positioning.

Also, as used herein, a sidelink positioning reference signal (SL-PRS) configuration is a set of configured parameters of a SL-PRS for a user device 102 to send sidelink signals/signaling. A SL-PRS configuration of a mode 1 user device 102 (i.e., a user device configured to operate in mode 1) may include a Tx SL-PRS resource pool of the mode 1 user device 102. In addition, the SL-PRS configuration may include at least one of: one or more associated SL-PRS resource pools of the SL-PRS configuration (the associated SL-PRS resource pool can be associated with one SL-PRS configuration, or with one or more SL-PRS resource sets in a SL-PRS configuration, or with one or more SL-PRS resources in a SL-PRS configuration; the SL-PRS resource pool may be a transmitting SL-PRS resource pool or a receiving SL-PRS resource pool), the identification (ID) of a SL-PRS (e.g., a SL-PRS resource ID, a SL-PRS resource set ID, or a SL-PRS resource configuration ID), the time domain resources of a SL-PRS (e.g., the periodicity of SL-PRS resource/resource set, the system frame number (SFN) 0 offset of the SL-PRS resource/resource set, a slot or symbol offset of one SL-PRS resource/resource set, a number of symbols of one SL-PRS resource, a repetition number of one SL-PRS resource/resource set, or a cyclic prefix of the SL-PRS resource/resource set), the frequency domain resources of a SL-PRS (e.g., the comb size and/or comb offset of the SL-PRS resource, the bandwidth of the SL-PRS resource/resource set, the start physical resource block (PRB) of the SL-PRS resource/SL-PRS resource set, the point A of the SL-PRS resource/resource set, the start sub-channel of the SL-PRS resource/SL-PRS resource set, and/or the number of sub-channels of the SL-PRS resource/SL-PRS resource set), the spatial domain resources of the SL-PRS (e.g., the PRS sequence ID, the QCL information of SL-PRS resource/resource set), the transmitting power of each SL-PRS resource, an indication of whether the SL-PRS resource/resource set is periodic, semi-persistent or aperiodic; or the priority index of SL-PRS resource/SL-PRS resource set. Also, a muting pattern may be used per RAN node or per several RAN nodes, or per SL-PRS resource or SL-PRS resource set.

Additionally, in various embodiments, Ranging and Sidelink Positioning Portocol (RSPP), which can also be called Sidelink positioning protocol (SLPP), is similar to LPP in the uu interface, and is a protocol between one user device 102 and another user device 102. For at least some embodiments, the sidelink positioning control signaling can be conveyed by one or more RSPP messages.

Also, as used herein, a SL-PRS resource conflict means the SL-PRS resources that are sent from two mode 1 user devices 102 have a conflict (or overlap) in the time domain and/or the frequency domain. For example, a SL-PRS resource conflict may occur when two user devices 102 send respective SL-PRSs in the same symbol, in the same PRBs, or in same sub-channels. In some situations, a SL-PRS conflict may cause two mode 1 user devices 102 to experience interference, especially if the two mode 1 user devices 102 are in close proximity to each other.

In addition, in sidelink positioning, a target user device 102 is a user device to be positioned, and an anchor user device 102 is the user device supporting positioning of the target user device 102, e.g., by transmitting and/or receiving reference signals for positioning, providing positioning-related information, etc., over a sidelink (SL) interface.

Also, in a sidelink communication, for a mode 1 user device 102, there may be two ways to perform resource allocation. A first way includes dynamic resource allocation, where the user device 102 receives the RRC configuration of a resource pool, and receives DCI 3-0 scrambled by a sidelink radio network temporary identifier (SL-RNTI) to acquire the dynamic sidelink resource for transmitting sidelink information. This first way may be used to allocate dynamic sidelink resources for emergent service. A second way includes configured grant (CG) resource allocation, which may include a Type 1 sidelink (SL CG) and/or a Type 2 SL CG. In Type 1 SL CG, a user device 102 receives a CG configuration, which may include a resource pool ID, a CG configuration ID, a CG periodicity, a CG resource allocation, and/or transmit sidelink information according to the indication in RRC. In Type 2 SL CG, the user device 102 receives the CG configuration, which may include a CG index and a CG periodicity, and receives the DCI 3-0 scrambled by SL-configured scheduling (CS)-RNTI to acquire the time/resource domain resources and the trigger of the CG.

FIG. 2 illustrates original Uu-positioning, the structure between different communication nodes in the original Uu-positioning. In the structure, one LMF 202 may take control of several (two or more) RAN nodes 204. In addition, one RAN node may include, or be considered as, a gNB. In addition, each gNB takes control of one or more TRPs.

In the original Uu-positioning, suppose DL positioning for example. The Uu-positioning procedure may include the following. In a first act, the LMF 202 may trigger one or more RAN nodes 204 to provide TRP information, including a PRS configuration. In a second act, the one or more RAN nodes 204 may respond to the LMF 202, and provide the TRP information along with the PRS configuration. In a third act, the LMF 202 transmits the TRP information along with PRS configuration as assistance data to a user device 102. In a fourth act, the LMF 202 may trigger the user device 102 to perform positioning. In a fifth act, the user device 102 receives PRSs from different TRPs (which may belong to different RAN nodes 204) and make measurements. In a sixth act, the user device 102 reports a measurement result and/or a positioning estimate to the LMF 202. Also, for at least some embodiments, in the second act, different RAN nodes 204 may provide their respective PRS configurations to the LMF 202 independently. Each RAN node 204 may not know the other RAN node's 204 PRS configuration. Each RAN node 204 may ensure the TRPs within one RAN node have non-overlapped PRS resources by setting one or more muting patterns.

FIG. 3 is a diagram that depicts an example of a sidelink positioning structure for an in-coverage scenario.

Additionally, for at least some embodiments, in sidelink positioning mode 1 scenario, different sidelink user devices 102 may have different serving gNBs. There may exist one or more mode 1 user devices 102 under one gNB's scope or coverage and can perform control signaling interaction (communicate control signals) with this gNB. Mode 1 user devices 102 under the scope of the same or different gNBs may receive different or non-overlapped SL-PRS configurations to avoid conflict when sending SL-PRSs to other sidelink user devices 102, especially for periodic SL-PRS transmission. If different serving gNBs provide SL-PRS configurations to the corresponding user devices 102, since different gNBs may not coordinate their SL-PRS configurations, or perform conflict resolution, with each other, then it is possible that the user devices 102 receive overlapped SL-PRS configurations (e.g., in the time domain and/or the frequency domain). This, in turn, may cause interference when the user devices 102 send their respective SL-PRSs according to the SL-PRS configurations. In other hand, if the RAN nodes 204 coordinate their respective SL-PRS configurations or otherwise perform conflict resolution, overlapping SL-PRS configurations may be avoided.

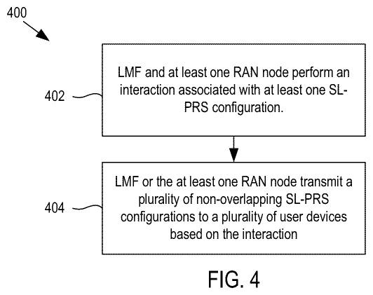

FIG. 4 is a flow chart of an example method 400 for wireless communication. At block 402, the LMF 202 and at least one RAN node 204 may perform an interaction associated with at least one SL-PRS configuration. At block 404, the LMF 202 or the at least one RAN node 204 may transmit a plurality of non-overlapping SL-PRS configurations to a plurality of user devices 102 based on the interaction.

In some embodiments of the method 400, at least one of, or each of, the plurality of non-overlapping SL-PRS configurations comprises at least one of: a priority index of a SL-PRS resource or a SL-PRS resource set, a muting pattern of the SL-PRS resource or the SL-PRS resource set, a slot or symbol offset of the SL-PRS resource or the SL-PRS resource set, a comb offset of the SL-PRS resource or the SL-PRS resource set, a start physical resource block (PRB) or a start sub-channel of the SL-PRS resource or the SL-PRS resource set.

In addition or alternatively, in some embodiments, the LMF 202 and/or the at least one RAN node 204 may determine whether a user device, such as of the plurality of user devices 102, is to adopt mode 1 or mode 2. For mode 1, the user device 102 transmits a SL-PRS according to a SL-PRS configuration that the LMF 202 or the at least one RAN node 204 transmits. For mode 2, the user device transmits 102 the SL-PRS without the SL-PRS configuration that the LMF 202 or the at least one RAN node 204 transmits. Additionally, the LMF 202 or the at least one RAN node 204 may transmit an indication of the determination to the user device.

In addition or alternatively, the LMF 202 and/or the at least one RAN node 204 may determine whether a user device 102, such as of the plurality of user devices 102, is to perform sidelink positioning, wherein the performance of the sidelink positioning comprises at least one of: making sidelink positioning measurements, transmitting a SL-PRS, or receiving the SL-PRS. Also, the LMF 202 and/or the at least one RAN node 204 may transmit an indication of the determination to the user device 102.

In addition or alternatively, the LMF 202 and/or the at least one RAN node 204 may perform the interaction by: communicating, from the LMF 202 to the at least one RAN node 204, a message to request the at least one RAN node 204 to transmit at least one SL-PRS configuration of at least one user device 102 to the LMF 202.

In addition or alternatively, the LMF 202 and the at least one RAN node 204 may perform the interaction by: communicating, from the at least one RAN node 204 to the LMF 202, a message comprising at least one SL-PRS configuration of at least one user device. In some embodiments, the LMF 202 may modify the at least one SL-PRS configuration, and the LMF 202 may communicate, to the at least one RAN node 204, a message that includes the at least one SL-PRS configuration of the at least one user device.

In addition or alternatively, the LMF 202 and the at least one RAN node 204 may perform the interaction by: communicating, from the LMF 202 to at least one RAN node 204, a message that includes at least one SL-PRS configuration of all of the plurality of user devices 102 in a same positioning session.

In addition or alternatively, the LMF 202 or the at least one RAN node 204 may transmit the plurality of non-overlapping SL-PRS configurations by the LMF 202 transmitting at least one of the plurality of non-overlapping SL-PRS configurations to at least one user device 102, such as via a Long-Term Evolution Positioning Protocol (LPP) message.

In addition or alternatively, the LMF 202 or the at least one RAN node 204 may transmit the plurality of non-overlapping SL-PRS configurations by the at least one RAN node 204 transmitting at least one of the plurality of non-overlapping SL-PRS configurations to at least one user device 102, such as via radio resource control (RRC) signaling.

In addition or alternatively, the LMF 202 and the at least one RAN node 204 may perform the interaction by: communicating, from the LMF 202 to the at least one RAN node 204, a message to trigger the at least one RAN node 204 to distribute at least one of the plurality of non-overlapping SL-PRS configurations to at least one user device 102.

In addition or alternatively, the LMF 202 and the at least one RAN node 204 may perform the interaction by: communicating, from the LMF 202 to the at least one RAN node 204, a message comprising radio resources. In some of these embodiments, the at least one RAN node 204 includes one or more RAN nodes 204 that have a SL-PRS resource conflict with one or more other RAN nodes 204.

In addition or alternatively, the LMF 202 an the at least one RAN node 204 may perform the interaction by: communicating, from the LMF 202 to the at least one RAN node 204, a message including a RAN node identification list that identifies a set of one or more RAN nodes 204 required to send at least one SL-PRS configuration to at least one of the plurality of user devices 102. For at least some of these embodiments, the LMF 202 and the at least one RAN node 204 may perform the interaction by: sending, from a first RAN node 204 to a second RAN node 204 identified in the RAN node identification list, a SL-PRS configuration of the first RAN node 204. In addition or alternatively, the LMF 202 and the at least one RAN node 204 may perform the interaction by: sending, from a first RAN node 204 to a second RAN node 204 identified in the RAN node identification list, a request to receive a SL-PRS configuration of the second RAN node 204.

In any of various embodiments, the message includes an identification of the user device.

In addition or alternatively, a first user device 102 of the plurality of user devices 102 may receive a SL-PRS from a second user device 102 of the plurality of user devices 102. For at least some of these embodiments, the SL-PRS is scheduled by: a sidelink control information (SCI) or a downlink control information (DCI). Also, in some embodiments where the SL-PRS is scheduled by the SCI, and the SCI is scheduled by: a downlink control information (DCI), Long-Term Evolution Positioning Protocol (LPP) signaling, or radio resource control (RRC) signaling. In addition or alternatively, where the SCI is scheduled by the LPP signaling or the RRC signaling, the LPP signaling or the RRC signaling includes a time offset between the transmission of the LPP signaling or the RRC signaling and the transmission of the SCI. In addition or alternatively, for embodiments where the SL-PRS is scheduled by the SCI, the SCI may be scheduled by a downlink control information (DCI), and the DCI may include a time offset between a transmission of the DCI and a transmission of the SCI.

Further details of various aspects or embodiments of the method 400 and/or operations of functions of the components of the wireless system 100 are now described.

Also, for at least some implementations, when the LMF 202 coordinates SL-PRS configurations of different RAN nodes 204, the LMF may know, decide, or determine: an in-coverage target user device's 102 sidelink positioning method, sidelink positioning session information, and whether the target user device 102 and the anchor user devices 102 within one sidelink positioning session adopts mode 1 or mode 2. In particular embodiments, the LMF 202 may decide or determine the target user device's 102 sidelink positioning method and tell or notify the user device 102, such as via LPP, and/or tell or notify a gNB, such as via NRPPa. Additionally, the LMF 202 may know the sidelink positioning session information (for example, which user devices 102 are in the same sidelink positioning session, and/or which RAN nodes 204 are in the same sidelink positioning session), and tell or notify user devices 102 via LPP, and/or tell or notify the RAN nodes 204, such as via NRPPa. Also, for at least some embodiments, the LMF 202 may decide or determine whether the in-coverage sidelink user devices 102 in a sidelink positioning session are to adopt mode 1, mode 2, or Uu-based positioning, and tell or notify the user devices 102, such as via LPP, and/or tell or notify the RAN nodes 204, such as via NRPPa. In addition or alternatively, a RAN node 204 may decide whether the in-coverage user devices 102 (under the RAN node's scope) in a sidelink positioning session are to adopt mode 1, mode 2, or Uu-based positioning, and tell or notify the user device(s) 102, such as via RRC signaling, and/or tell or notify the LMF 202, such as via NRPPa.

Also, for at least some implementations, the LMF 202 may determine whether a target user device 102 is to adopt PC5 positioning only (e.g., where the target user device 102 only transmits and/or receives SL-PRS and makes SL-PRS measurements, but can receive control signaling for sidelink communication from the wireless access node 104 in the in-coverage scenario), or whether the target user device 102 is to adopt combined PC5 positioning and Uu positioning (where the target user device 102 performs sidelink positioning via PC5 interface via RSPP, and the target user device 102 also obeys the original LPP/RRC construction to receive downlink positioning reference signals (DL-PRS) or send sounding reference signals (SRS), and make DL-PRS measurements).

In addition, for at least some embodiments, the LMF may coordinate based on the implementation of the LMF 202. In particular, after the LMF 202 knows the positioning requirement from a location services (LCS) client (MT-LR) or a target user device 102 (MO-LR), that sidelink positioning for the target user device 102 may be used or needed, and the actions performed for a mode 1 user device 102 to acquiring the network's configured SL-PRS configuration for sending SL-PRS may be performed as follows (without necessarily being performed in the order recited herein).

In a first act, the LMF 202 may send a request message via NRPPa to trigger each RAN node 204 (which are involved in this sidelink positioning session) to provide their respective SL-PRS configurations for the mode 1 user devices 102 under their respective scope. In some embodiments, the request message may include the mode 1 UE's UE identification.

In a second act, each RAN node 204 may receive the LMF's 202 request message and configure the SL-PRS configuration for the mode 1 user devices 102 under their respective coverage. In addition, each RAN node 204 may consider the real-time radio resources to ensure the SL-PRS configurations of different mode 1 user devices 102 under the same RAN node 204 are non-overlapped. Then, each NG-RAN node 204 may provide the response message to the LMF 202, where the response message includes the configured/allocated SL-PRS configuration of each mode 1 user device 102. For example, each RAN node 204 may provide a user device ID list, where each user device ID in the user device ID list corresponds to a respective SL-PRS configuration. Also, in some embodiments, the RAN nodes 204 may provide a corresponding update message or failure message toward the LMF request in the first act.

In a third act, after the LMF 202 receives or acquires all of the RAN nodes 204 SL-PRS configurations, the LMF 202 may resolve any interference by or according to the LMF's 202 implementation. For example, the LMF 202 may delete some of the overlapping SL-PRS resources of some of the RAN nodes 204. Then, the LMF 202 may provide the non-overlapped SL-PRS configurations to mode 1 user devices 102, such as via LPP signaling. Also, the LMF 202 may provide the mode 1 user devices 102 with the SL-PRS configurations, which are the configurations of the mode 1 user device's 102 serving RAN node 204.

In addition or alternatively, in some embodiments, the LMF 202 coordinates with the gNBs. Such such embodiments, after the LMF 202 knows the positioning requirements from LCS client (MT-LR) or the target user device 102 (MO-LR) that sidelink positioning for the target user device 102 is needed, the actions performed for the mode 1 user device 102 to acquiring the network's configured SL-PRS configuration for sending SL-PRS may be performed as follows (without necessarily being performed in the order recited herein).

In a first act, the LMF 202 may send a request message, such as via NRPPa, to trigger each RAN node 204 (which are involved in this sidelink positioning session) to provide their respective SL-PRS configurations for mode 1 user devices 102 under their respective scopes. In some embodiments, the request message may include the mode 1 user device's 102 UE identification. In addition or alternatively, the request message may include a request that the LMF 202 requests the RAN nodes 204 to distribute the SL-PRS configuration to the corresponding mode 1 user devices 102.

In a second act, each RAN node 204 may receive the LMF's 202 request message and configure the SL-PRS configuration for the mode 1 user devices 102 that are under the RAN node's 204 coverage (scope). A RAN node 204 may consider the real-time radio resources to ensure the SL-PRS configurations of different mode 1 user devices 102 do not overlap. Then, each RAN node 204 provides the response message to the LMF 202 including the configured/allocated SL-PRS configurations of each mode 1 user device 102. For example, the RAN node 204 may provide a user device ID list, where each user device ID in the user device ID list corresponds to a respective SL-PRS configuration. In addition, for some embodiments, the RAN nodes 204 may provide the corresponding update message or failure message towards the LMF request in the first act.

In a third act, for some embodiments, after the LMF 202 acquires all of the RAN nodes' 204 SL-PRS configurations, the LMF 202 may recommends some radio resources to some of the RAN nodes 204 that have SL-PRS resources that conflict with other RAN nodes. The LMF may make the recommendation in order to avoid SL-PRS resource conflict between the RAN nodes 204. Also, as used herein, ‘recommend’ may include sending a message. So, when the LMF 202 recommends radio resources to a RAN node 204, the LMF 202 may do so by sending a message, such as via NRPPa signaling, that includes the radio resources to RAN node 204. Also, the radio resources that the LMF 202 recommends to one RAN node 204 do not overlap with radio resources of other RAN nodes 204. In any of various embodiments, the radio resources may include at least one of: the SFN0 offset of the SL-PRS resource/resource set, the SL-PRS resource/resource set slot or symbol offset, the SL-PRS resource/resource set periodicity, the SL-PRS resource/resource set symbol number, the cyclic prefix of SL-PRS resource/resource set, the SL-PRS resource/resource set repetition number, the SL-PRS resource/resource set bandwidth, the SL-PRS resource/resource set start PRB, the SL-PRS resource/resource set point A, the sidelink PRS resource/resource set comb size, the sidelink PRS resource/resource set comb offset, the PRS sequence ID, the quasi colocation (QCL) information of the SL-PRS resource/resource set, the power of each SL-PRS resource, the priority index of each SL-PRS resource/resource set, or the muting pattern of each NG-RAN node. Also, the NRPPa message may also contain the user device identification(s) associated with the radio resources.

In other embodiments of the third act, the LMF 202, upon acquiring all of the SL-PRS configurations from the RAN nodes 204, the LMF 202 may send the SL-PRS configurations to a set of RAN nodes, where the set of RAN nodes (which may include less than all of the RAN nodes 204), includes the RAN nodes that the LMF 202 identifies as having SL-PRS resources overlapping with SL-PRS resources of one or more other RAN nodes 204, or includes all of the RAN nodes 204 that send SL-PRS configurations to mode 1 user devices 102.

In still other embodiments of the third act, the LMF 202 may configure a muting pattern according to the NG-RAN nodes' SL-PRS configurations. In any of various embodiments, the muting pattern may be configured per RAN node 204 per user device 102, configured per RAN node 204, or configured per SL-PRS resource set. Usage of the muting pattern is to let each RAN node 204 have non-overlapped SL-PRS configurations in resources. For at least some embodiments, the muting pattern is a bitmap. In some embodiments of the bitmap, a value 1 indicates the SL-PRS resource ID or SL-PRS resource set ID that the RAN node 204 configures for one user device 102. Also, the LMF 202 may transmit the muting pattern to the corresponding NG-RAN node 204. In addition or alternatively, the muting pattern is part of the SL-PRS configuration.

In a fourth act, the RAN nodes 204 may modify the SL-PRS configuration according to the LMF's 204 recommendation. The RAN nodes 204 may send the response message including the modified SL-PRS configuration for each mode 1 user device 102 to LMF 202.

In a fifth act, the LMF 202 may distribute the SL-PRS configuration(s) of each RAN node 204 to each mode 1 user device 102. In some embodiments, the LMF 202 may send a message to request the RAN nodes 204 to distribute the SL-PRS configurations to the corresponding mode 1 user devices 102. For at least some embodiments, the request message may be same as the request message sent in act above described above. In other embodiments, the request message may be a separate message in the NRPPa signalling. Also, the RAN nodes 204 may distribute the modified SL-PRS configuration to each mode 1 user device 102

Additionally, in some embodiments, the LMF 202 may request that the gNBs coordinate with each other. In doing so, the LMF 202 may need to know or decide: the in-coverage target user device's 102 sidelink positioning method, the sidelink positioning session information, and whether the target user device 102 and the anchor user devices 102 within one sidelink positioning session adopt mode 1 or mode 2. In particular embodiments, the LMF may decide the target user device's 102 sidelink positioning method and tell or notify the user device 102, such as via LPP, and/or tell or notify the gNB, such as via NRPPa. In addition or alternatively, the LMF 202 may know the sidelink positioning session information (for example, which user devices 102 are in the same sidelink positioning session, and/or which RAN nodes 204 are in the same sidelink positioning session) and tell or notify the user devices 102, such as via LPP, and/or tell or notify the RAN nodes 204, such as via NRPPa. The LMF 202 may decide whether the sidelink user devices 102 in a sidelink positioning session should or are to adopt mode 1 or mode 2, and tell or notify the user device 102 via LPP, and/or tell or notify the NG-RAN nodes 204, such as via NRPPa.

In some embodiments, the LMF 202 may request every RAN node 202 to coordinate, and one or more SL-PRS configurations are modified. In such embodiments, after the LMF 202 knows the positioning requirement from LCS client (MT-LR) or the target user device 102 (MO-LR) that sidelink positioning for the target user device 102 is needed, the actions performed for the mode 1 user device 102 to acquire the network's configured SL-PRS configurations for sending the SL-PRS may be performed as follows (without necessarily being performed in the order recited herein).

In a first act, the LMF 202 may send a request message, such as via NRPPa, to trigger each RAN node 204 (which are involved in this sidelink positioning session) to provide the SL-PRS configurations for the mode 1 user devices 102 under their respective scopes. In some embodiments, the request message may include the mode 1 user device's 102 identification.

In a second act, the LMF 202 may send a request message to each RAN node 204. The request message may include a RAN node ID list, which includes one or more of IDs of the RAN nodes 204 to configure the SL-PRS configurations for mode 1 user devices 102. The request message is to request each RAN node 204 to coordinate SL-PRS configurations with the RAN nodes 204 in the RAN node ID list, which in turn may avoid SL-PRS resource conflict between different RAN nodes 204.

In a third act, each RAN node 204 may set up an Xn interface with the other RAN nodes 204 indicated in the RAN node ID list. In addition, in some embodiments, a NG-RAN node 204 may send the SL-PRS configuration of itself to other RAN nodes via the Xn interface. In other embodiments, the RAN node 204 may send the request message to other RAN nodes 204 in the NG-RAN node list to request them provide their SL-PRS configuration(s) via the Xn interface.

In a fourth act, after the third act, it may be assumed that each RAN node 204 has the SL-PRS configurations of the other RAN nodes 204. Correspondingly, each RAN node 204 may modify the SL-PRS configurations to not overlap with each other. For example, if there are a total of two RAN nodes 204 requested by the LMF 202 to coordinate the SL-PRS configuration, a first RAN node 204 sends a SL-PRS configuration of itself to a second RAN node 204, and in response, the second RAN node 204 may decide whether there is SL-PRS configuration conflict. If there is, the second RAN node 204 may modify the SL-PRS configuration of the second RAN node 204. In other embodiments, the second RAN node 204 may send the non-overlapped SL-PRS to the first RAN node 204.

In a fifth act, each RAN node 204 may provide non-overlapped SL-PRS configurations to the LMF 202. In a sixth act, each RAN node 204 may provide non-overlapped SL-PRS configurations to the corresponding mode 1 user devices 102. In a seventh act, the LMF 202 may provide the non-overlapped SL-PRS configurations of different RAN nodes 204 to corresponding mode 1 user devices 102.

In addition, in some embodiments, the LMF may request one RAN node to coordinate the SL-PRS configurations. For such embodiments, after the LMF 202 knows the positioning requirements from the LCS client (MT-LR) or the target user device 102 (MO-LR), and knows that sidelink positioning for the target user device 102 is needed, the actions for a mode 1 user device 102 to acquire the network's configured SL-PRS configuration for sending a SL-PRS may be performed as follows (without necessarily being performed in the order recited herein).

In a first act, the LMF 202 may send a request message to one of one or more RAN nodes. The request message may include a NG-RAN node ID list, which includes one or more of the NG-RAN nodes' IDs required to configure SL-PRS configurations for mode 1 user devices 102. The request message may be to request the RAN nodes 204 to coordinate the SL-PRS configurations with the RAN nodes 204 in the RAN node ID list, in order to avoid SL-PRS resource conflict between different RAN nodes 204. The requested RAN node 204 may be a serving RAN node 204 (e.g., a serving gNB) of the target user device 102.

In a second act, the RAN node 204 may set up a Xn interface with the other RAN nodes 204 indicated in the RAN node ID list, and the RAN node 204 sends the SL-PRS configuration of itself to other RAN nodes via the Xn interface. In other embodiments, the RAN node 204 may send the request message to the other RAN nodes 204 in the RAN node list to request them provide their respective SL-PRS configurations.

In a third act, after receiving one RAN node's SL-PRS configuration, the other RAN nodes 204 may configure non-overlapped SL-PRS configurations. For example, if the LMF 202 requests a first RAN node 204 to coordinate with a second RAN node 204, the first RAN node 204 may send the SL-PRS configuration of itself to the second RAN node 204, and in response, the second RAN node 204 may configure the non-overlapped SL-PRS configuration with the first RAN node 204. In other embodiments, the second RAN node may send the non-overlapped SL-PRS to the first RAN nod 204.

In a fourth act, the requested RAN node 204 in the first act may provide non-overlapped SL-PRS configurations of all the RAN nodes 204 to the LMF 202. In a fifth act, each RAN node 204 may provide non-overlapped SL-PRS configurations to their corresponding mode 1 user devices 102. In a sixth act, the LMF 202 may provide the non-overlapped SL-PRS configurations of different RAN nodes 204 to the corresponding mode 1 user devices 102.

In addition, for at least some embodiments, a SL-PRS transmission by a user device 102 may support at least one of: dynamic resource allocation, Type 1 SL CG, or Type 2 SL CG. Also, the gNB may decide whether the mode 1 user device 102 is to adopt dynamic resource allocation, Type 1 SL CG, or Type 2 SL CG, and indicate the decision to the user device 102. In particular embodiments, for dynamic resource allocation, a serving RAN 204 node may provide a first sub-set of one or more SL-PRS configurations to a mode 1 user device 102, such as via RRC signaling, and may provide a second sub-set of one or more SL-PRS configurations mode 1 user devices 102 via a DCI. Also, for Type 1 SL PRS CG, a serving RAN node 204 or the LMF 202 may send a full or complete set of SL-PRS configurations to mode 1 user devices 102. In addition, for Type 2 SL PRS CG, a serving RAN node 204 may provide a third sub-set of one or more SL-PRS configurations and a CG configuration to mode 1 user devices 102, such as via RRC signaling, and may provide a fourth sub-set of one or more SL-PRS configurations to mode 1 user devices, such as via DCI. In other embodiments, for Type 2 SL PRS CG, a serving RAN node 204 may provide a full or complete set of SL-PRS configurations and CG configuration to mode 1 user devices 102, and trigger the user devices 102 to send their respective SL-PRSs, such as via DCI.

Also, for at least some embodiments, a CG configuration may include at least one of: a CG index, a period of CG, a time domain resource of the CG, a frequency domain resource of the CG, an associated resource pool ID, a PUCCH resource for the feedback to the network 104. The CG configuration may be dedicated for SL-PRS and may be different with CG configuration of sidelink data, or, the CG configuration of SL-PRS may reuse the CG configuration of sidelink data.

In addition, for at least some embodiments, the DCI may be a DCI format DCI x-y, which may be the same as or different than existing DCI formats, where x and y are both integers. The DCI of Type 2 SL PRS CG may be different or independent of the DCI of dynamic resource allocation, or, the 2 kinds of DCIs may share the same DCI format but with different scrambles. The DCI may include at least one of: a time offset between the DCI and the SCI that schedules the SL-PRS; a SL-PRS resource ID/resource set ID indicated for a user device 102 to transmit the SL-PRS; one or more triggered CG indices; a time domain resource of the SL-PRS/SL-PRS resource set; a frequency domain resource of the SL-PRS/SL-PRS resource set; or a spatial domain resource of the SL-PRS/SL-PRS resource set. In addition, in any of various embodiments, the RAN nodes 204 may tell or notify the LMF 202 whether the mode 1 user devices 102 supports dynamic resource allocation, Type 1 SL PRS CG, or Type 2 SL PRS CG.

In addition, for embodiments where the LMF 202 is to distribute SL-PRS configurations to each mode 1 user device, such as via LPP signaling, if the SL-PRS resource is aperiodic, the user device 102 may send a SCI to trigger the SL-PRS transmission. In addition or alternatively, if the SL-PRS resource is periodic, then when the user device 102 receives the SL-PRS configuration LPP message, the user device 102 may start transmitting a periodic SL-PRS according to the SL-PRS configuration.

In addition, Mode 1 may include at least one of: the network 104 allocates a periodic SL-PRS configuration to a user device 102; a gNB allocates a periodic SL-PRS configuration to a user device 102 via RRC; a gNB allocates a semi-persistent or an aperiodic SL-PRS configuration to a user device 102 via RRC signaling, a medium access control control element (MAC-CE) or a DCI triggers the SCI and/or the SL-PRS transmission; the LMF 202 allocates a periodic SL-PRS configuration via LPP; the LMF 202 allocates a semi-persistent or an aperiodic SL-PRS configuration via LPP, or the SCI triggers the SL-PRS transmission.

In addition or alternatively, for embodiments where a RAN node 204 is to distribute the SL-PRS configurations to each mode 1 user device 102, such as via RRC signaling, if the SL-PRS resource is aperiodic, the user device 102 may receive a DCI containing the trigger of the SCI that schedules the SL-PRS, or containing the trigger of an aperiodic SL-PRS. In other embodiments, if the SL-PRS resource is aperiodic, the user device 102 may transmit a SCI to trigger the SL-PRS. In particular of these embodiments, the user device 102 may transmit the SCI without receiving a DCI that triggers the SCI or the SL-PRS. In addition or alternatively, for embodiments where the SL-PRS resource is semi-persistent, the user device 102 may receive medium access control control element (MAC-CE) that includes the trigger of the SCI that schedules the SL-PRS, or that includes the trigger of an aperiodic SL-PRS. Also, for embodiments where the SL-PRS resource is periodic, the user device 102 may start to transmit the SL-PRS according to the periodic SL-PRS configuration immediately after the user device 102 receives the RRC signaling. Additionally, in some embodiments, the LPP signaling or the RRC signaling may include a time offset between the LPP signaling or the RRC signaling and the SCI transmission.

In addition, in some embodiments, the DCI may have a DCI x-y format, which may be the same as or different than existing DCI formats, where x and y are both integers. In event that the DCI format is to reuse an existing DCI format, some new fields may be included. The DCI, the SCI or the MAC-CE may include at least one of the following: a resource pool associated with the triggered SL-PRS resource/resource set; a time offset between the DCI and the SCI that schedules SL-PRS; a time offset between the DCI and the first SL-PRS resource/resource set instance; a time offset between the SCI and the first SL-PRS resource/resource set instance; a SL-PRS resource ID/resource set ID indicated for the user device 102 to transmit the SL-PRS; a time domain resource of the SL-PRS/SL-PRS resource set; a frequency domain resource of the SL-PRS/SL-PRS resource set; or a spatial domain resource of SL-PRS/SL-PRS resource set. Additionally, in any of various embodiments, the time offset have the unit of milliseconds, slot, and/or symbol.

In addition, when a SL-PRS configuration is provided to a mode 1 user device 102, a priority index of the SL-PRS resource/resource set may also be provided. The priority index may be a 1 bit value, which tells or informs the user device 102 whether or not the SL-PRS resource/resource set can be transmitted by the user device 102. In some embodiments, the priority index may be configured by the LMF 202 after the LMF 202 acquires all of the RAN nodes' 204 SL-PRS configurations. Additionally, the LMF 202 may send the priority index associated with each SL-PRS resource/resource set to a user device 102, such as via LPP signaling. In addition or alternatively, the LMF 202 may tell each RAN node 204 the muting pattern of all the SL-PRS/SL-PRS resource sets within a RAN node 204, such as via NRPPa signaling. In turn, the NG-RAN node 204 may send the SL-PRS configuration with a priority index to a certain user device 102, such as via RRC signaling. In other embodiments, the LMF 202 may tell or notify each RAN node 204 the muting pattern of all the SL-PRS/SL-PRS resource sets within a RAN node 204 for a certain user device 102, such as via NRPPa. In turn, then RAN node 204 may tell or send the SL-PRS configuration including the priority index to the user device, such as via RRC signaling. In this case, the muting pattern may be the priority index. In other embodiments, the user device may also receive the association between a priority index and the SL-PRS resource ID/resource set ID in a DCI.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: performing, with a location management function (LMF) and at least one radio access network (RAN) node, an interaction associated with at least one sidelink positioning reference signal (SL-PRS) configuration; and transmitting, with the LMF or the at least one RAN node, a plurality of non-overlapping SL-PRS configurations to a plurality of user devices based on the interaction.

A second aspect includes the first aspect, and further includes: wherein the at least one SL-PRS configuration comprises at least one of: a priority index of a SL-PRS resource or a SL-PRS resource set, a muting pattern of the SL-PRS resource or the SL-PRS resource set, a slot or symbol offset of the SL-PRS resource or the SL-PRS resource set, a comb offset of the SL-PRS resource or the SL-PRS resource set, a start physical resource block (PRB) or a start sub-channel of the SL-PRS resource or the SL-PRS resource set.

A third aspect includes any of the first or second aspects, and further includes: determining, with the LMF or the at least one RAN node, whether a user device is to adopt mode 1 or mode 2, wherein for mode 1, the user device transmits a SL-PRS according to a SL-PRS configuration that the LMF or the at least one RAN node transmits, and for mode 2, the user device transmits the SL-PRS without the SL-PRS configuration that the LMF or the at least one RAN node transmits; and transmitting, with the LMF or the at least one RAN node, an indication of the determination to the user device.

A fourth aspect includes any of the first through third aspects, and further includes: determining, with the LMF or the at least one RAN node, whether a user device is to perform sidelink positioning, wherein the performance of the sidelink positioning comprises at least one of: making sidelink positioning measurements, transmitting a SL-PRS, or receiving the SL-PRS; and transmitting, with the LMF or the at least one RAN node, an indication of the determination to the user device.

A fifth aspect includes any of the first through fourth aspects, and further includes wherein performing the interaction comprises: communicating, from the LMF to the at least one RAN node, a message to request the at least one RAN node to transmit at least one SL-PRS configuration of at least one user device to the LMF.

A sixth aspects includes any of the first through fifth aspects, and further includes wherein performing the interaction further comprises: communicating, from the at least one RAN node to the LMF, a message comprising at least one SL-PRS configuration of at least one user device.

A seventh aspect includes the sixth aspect, and further includes: modifying, with the LMF, the at least one SL-PRS configuration; and communicating, from the LMF to the at least one RAN node, a message comprising the at least one SL-PRS configuration of the at least one user device.

An eighth aspect includes any of the first through seventh aspects, and further includes wherein performing the interaction further comprises: communicating, from the LMF to at least one RAN node, a message comprising at least one SL-PRS configuration of all of the plurality of user devices in a same positioning session.

A ninth aspect includes any of the first through eighth aspects, and further includes transmitting the plurality of non-overlapping SL-PRS configurations comprises: transmitting, with the LMF, at least one of the plurality of non-overlapping SL-PRS configurations to at least one user device via a Long-Term Evolution Positioning Protocol (LPP) message.

A tenth aspect includes any of the first through ninth aspects, and further includes wherein transmitting the plurality of non-overlapping SL-PRS configurations comprises: transmitting, with the at least one RAN node, at least one of the plurality of non-overlapping SL-PRS configurations to at least one user device via radio resource control (RRC) signaling.

An eleventh aspect includes any of the first through tenth aspects, and further includes wherein performing the interaction comprises: communicating, from the LMF to the at least one RAN node, a message to trigger the at least one RAN node to distribute at least one of the plurality of non-overlapping SL-PRS configurations to at least one user device.

A twelfth aspect includes any of the first through eleventh aspects, and further includes wherein performing the interaction comprises: communicating, from the LMF to the at least one RAN node, a message comprising radio resources.

A thirteenth aspect includes the twelfth aspect, and further includes wherein the at least one RAN node comprises one or more RAN nodes that have a SL-PRS resource conflict with one or more other RAN nodes.

A fourteenth aspect includes any of the first through thirteenth aspects, and further includes wherein performing the interaction comprises: communicating, from the LMF to the at least one RAN node, a message comprising a RAN node identification list that identifies a set of one or more RAN nodes required to send at least one SL-PRS configuration to at least one of the plurality of user devices.

A fifteenth aspect includes the fourteenth aspect, and further includes wherein the at least one RAN node comprises a first RAN node and a second RAN node, wherein performing the interaction further comprises: sending, from the first RAN node to the second RAN node identified in the RAN node identification list, a SL-PRS configuration of the first RAN node.

A sixteenth aspect includes the fourteenth aspect, and further includes wherein performing the interaction further comprises: sending, from a first RAN node to a second RAN node identified in the RAN node identification list, a request to receive a SL-PRS configuration of the second RAN node.

A seventeenth aspect includes any of the fifth through eighth, eleventh, twelfth, or fourteenth aspects, and further includes wherein the message comprises an identification of the user device.

An eighteenth aspect includes any of the first through seventeenth aspects, and further includes receiving, with a first user device, a SL-PRS from a second user device.

A nineteenth aspect includes the eighteenth aspect, and further includes the SL-PRS is scheduled by: a sidelink control information (SCI) or a downlink control information (DCI).

A twentieth aspect includes the nineteenth aspect, and further includes wherein the SL-PRS is scheduled by the SCI, and wherein the SCI is scheduled by: a downlink control information (DCI), Long-Term Evolution Positioning Protocol (LPP) signaling, or radio resource control (RRC) signaling.

A twenty-first aspect includes the nineteenth aspect, and further includes wherein the SCI is scheduled by the LPP signaling or the RRC signaling, and wherein the LPP signaling or the RRC signaling comprises a time offset between the transmission of the LPP signaling or the RRC signaling and the transmission of the SCI.

A twenty-second aspect includes the nineteenth aspect, and further includes wherein the SL-PRS is scheduled by the SCI, and the SCI is scheduled by a downlink control information (DCI), and wherein the DCI comprises a time offset between a transmission of the DCI and a transmission of the SCI.

A twenty-third aspect includes a wireless communications apparatus comprising a processor and a memory, wherein the processor is configured to read code from the memory to implement any of the first through twenty-second aspects.

A twenty-fourth aspect includes a computer program product comprising a computer-readable program medium comprising code stored thereupon, the code, when executed by a processor, causing the processor to implement any of the first through twenty-second aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, by a first user device, a sidelink positioning reference signal (SL-PRS) from a second user device,
wherein the SL-PRS is scheduled by a sidelink control information (SCI), and
wherein the SCI is triggered by: a downlink control information (DCI) or a radio resource control (RRC) signaling.

2. The method of claim 1, wherein the SCI comprises at least one of:
a SL-PRS resource identification (ID) indicated for the second user device to transmit the SL-PRS; or
a time domain resource of the SL-PRS resource.

3. The method of claim 1, wherein the DCI comprises at least one of:
a SL-PRS transmission resource pool associated with the scheduled SL-PRS resource;
a time offset between the DCI and the SCI that schedules the SL-PRS; or
a time offset between the DCI and a first SL-PRS resource instance.

4. The method of claim 1, further comprising:
receiving, by the second user device, one or more SL-PRS configurations and a configured grant (CG) configuration from a radio access network (RAN) node.

5. The method of claim 4, wherein at least one of the one or more SL-PRS configurations is received via a radio resource control (RRC) signaling or the DCI.

6. The method of claim 4, wherein the one or more SL-PRS configurations comprises a set of configured parameters of the SL-PRS for the second user device to send the SL-PRS.

7. The method of claim 6, wherein the one or more SL-PRS configurations further comprises at least one of:
one or more associated SL-PRS transmission resource pools of the one or more SL-PRS configurations;
an identification (ID) of the SL-PRS resource;
a periodicity of the SL-PRS resource;
a slot or symbol offset of the SL-PRS resource;
a number of symbols of the SL-PRS resource;
a repetition number of the SL-PRS resource;
a comb size of the SL-PRS resource;
a comb offset of the SL-PRS resource;
a start physical resource block (PRB) of the SL-PRS resource;
a number of sub-channels of the SL-PRS resource; or
a transmitting power of the SL-PRS resource.

8. The method of claim 1, wherein the second user device comprises a mode 1 user device.

9. The method of claim 8, wherein the one or more SL-PRS configurations of the mode 1 user device comprises a SL-PRS transmission resource pool of the mode 1 user device.

10. A method for wireless communication, the method comprising:
transmitting, by a second user device, a sidelink positioning reference signal (SL-PRS) to a first user device,
wherein the SL-PRS is scheduled by a sidelink control information (SCI), and
wherein the SCI is triggered by: a downlink control information (DCI) or a radio resource control (RRC) signaling.

11. The method of claim 10, wherein the SCI comprises at least one of:
a SL-PRS resource identification (ID) indicated for the second user device to transmit the SL-PRS; or
a time domain resource of the SL-PRS resource.

12. The method of claim 10, wherein the DCI comprises at least one of:
a SL-PRS transmission resource pool associated with the scheduled SL-PRS resource;
a time offset between the DCI and the SCI that schedules the SL-PRS;
a time offset between the DCI and a first SL-PRS resource instance.

13. The method of claim 10, wherein the second user device transmits the SL-PRS according to a set of configured parameters of one or more SL-PRS configurations.

14. A method for wireless communication, the method comprising:
transmitting, by a radio access network (RAN) node, one or more sidelink positioning reference signal (SL-PRS) configurations and a configured grant (CG) configuration to a second user device,
wherein the one or more SL-PRS configurations comprises a set of configured parameters for the second user device to send a SL-PRS to a first user device.

15. The method of claim 14, wherein at least one of the one or more SL-PRS configurations is transmitted via a radio resource control (RRC) signaling or a downlink control information (DCI).

16. The method of claim 14, wherein the one or more SL-PRS configurations further comprises at least one of:
one or more associated SL-PRS transmission resource pools of the one or more SL-PRS configurations;
an identification (ID) of the SL-PRS resource;
a periodicity of the SL-PRS resource;
a slot or symbol offset of the SL-PRS resource;
a number of symbols of the SL-PRS resource;
a repetition number of the SL-PRS resource;
a comb size of the SL-PRS resource;
a comb offset of the SL-PRS resource;
a start physical resource block (PRB) of the SL-PRS resource;
a number of sub-channels of the SL-PRS resource; or
a transmitting power of the SL-PRS resource.

17. The method of claim 14, wherein the second user device comprises a mode 1 user device.

18. A wireless communications apparatus comprising a processor and a memory, wherein the processor is configured to read code from the memory to implement a method of claim 1.

19. A wireless communications apparatus comprising a processor and a memory, wherein the processor is configured to read code from the memory to implement a method of claim 10.

20. A wireless communications apparatus comprising a processor and a memory, wherein the processor is configured to read code from the memory to implement a method of claim 14.
